(19) United States
(12) Patent Application Publication
(10) Pub. No.: US 2026/0369852 A1
(43) Pub. Date: Nov. 19, 2026

(54) Battery Cell

(71) Applicant: SK On Co., Ltd., Seoul (KR)

(72) Inventor: Yea-Eun KIM, Daejeon (KR)

(21) Appl. No.: 19/515,524

(22) PCT Filed: Jul. 31, 2024
(86) PCT No.: PCT/KR2024/011282

§ 371 Date: Mar. 2, 2026

(30) Foreign Application Priority Data
Sep. 4, 2023 (KR) 10-2023-0116985

(51) Int. Cl. H01M 50/636

(52) U.S. Cl. CPC H01M 50/636

(57) ABSTRACT

A battery cell according to one embodiment of the present disclosure comprises: an electrode assembly; a container accommodating the electrode assembly in the inner space thereof, and including an injection port through which a liquid injected into the inner space passes in the injection direction toward the electrode assembly; and an injection guide disposed between the electrode assembly and the injection port in the inner space, wherein the injection guide can guide the liquid injected into the inner space through the injection port in a first direction and a second direction, which are perpendicular to the injection direction.

### TECHNICAL FIELD

The present disclosure relates to a battery cell.

### BACKGROUND ART

Secondary batteries (battery cells), unlike primary batteries, offer the convenience of rechargeability, making them a popular power source for various mobile devices, electric vehicles, and the like.

Such secondary batteries may have a structure in which the electrode assembly, formed by stacking a cathode plate, an anode plate, and a separator or by winding all thereof into the form of a roll, is housed within a case.

Meanwhile, the case may be equipped with an injection port to inject an electrolyte, and the hydraulic pressure of the injected electrolyte may damage the electrode assembly or cause fatigue to accumulate, potentially leading to battery cell malfunctions during continuous charging and discharging.

Furthermore, the path through which the electrolyte flows depends solely on the number of injection ports, and thus, if only one injection port is provided, the electrolyte may not spread evenly within the case, making it difficult to impregnate the electrode assembly evenly.

Therefore, a structure that may minimize or prevent damage to the electrode assembly caused by the electrolyte injected into the case and guide the flow of the electrolyte is required.

### DISCLOSURE OF INVENTION

### Technical Problem

An aspect of the present disclosure is to provide a battery cell in which a liquid, such as an electrolyte or the like, injected through an injection port is prevented from directly contacting an electrode assembly.

According to another aspect of the present disclosure, a battery cell may be provided in which a fluid, such as an electrolyte or the like, injected through an injection port, may be evenly distributed within a case.

### Solution to Problem

According to an aspect of the present disclosure, a battery cell includes an electrode assembly; a container accommodating the electrode assembly in an inner space and including an injection port through which liquid injected into the inner space passes along an injection direction toward the electrode assembly; and an injection guide disposed between the electrode assembly and the injection port in the inner space, wherein the injection guide guides the liquid injected into the inner space in a first direction perpendicular to the injection direction and a second direction perpendicular to the first direction.

According to an embodiment, the injection port, the injection guide, and the electrode assembly may be mutually disposed to overlap at least partially with respect to the injection direction.

According to an embodiment, the injection guide may include a first guide portion extending first direction to guide the liquid injected into the inner space in the injection direction in the first direction; and a second guide portion extending from the first guide portion in the second direction to guide the liquid flowing in the first direction along the first guide portion, in the second direction.

According to an embodiment, the container may include a case having an opening formed therein to accommodate the electrode assembly; and a cap plate coupled to the case to cover the opening, and the injection port may be formed by penetrating through the cap plate in the injection direction.

According to an embodiment, the first guide portion may be inclined in a direction approaching the electrode assembly.

According to an embodiment, the first guide portion may include a fluid distribution portion disposed below the injection port; and an inclined portion extending inclinedly from the fluid distribution portion in a direction approaching the electrode assembly, and among the fluid distribution portion and the inclined portion, the fluid distribution portion may be disposed closer to the injection port.

According to an embodiment, the inclined portion may include a first inclined portion extending inclinedly from one side of the fluid distribution portion in the first direction; and a second inclined portion extending in the first direction from the other side of the fluid distribution portion to be inclined in a direction opposite to the first direction.

According to an embodiment, the first inclined portion and the second inclined portion may have the same inclined angle.

According to an embodiment, the fluid distribution portion may be disposed to at least partially overlap the injection port in the injection direction.

According to an embodiment, the second guide portion may extend inclinedly from the first guide portion to approach the electrode assembly.

According to an embodiment, among the first guide portion and the second guide portion, the first guide portion may be disposed closer to the injection port, and the second guide portion may be disposed closer to the electrode assembly.

According to an embodiment, the second guide portion may extend inclinedly in both directions from the first guide portion along the second direction.

According to an embodiment, the second guide portion may include a first discharge portion extending inclinedly to one side from the first guide portion along the second direction; and a second discharge portion extending to the other side from the first guide portion along the second direction to be inclined in an opposite direction to the first discharge portion.

According to an embodiment, the first discharge portion and the second discharge portion may face each other at the same angle.

According to an embodiment, the first discharge portion and the second discharge portion may be disposed alternately along the first direction in the first guide portion.

According to an embodiment, the injection guide may be provided with a plurality of shower holes penetrating through a flow path through which the liquid flows.

According to an embodiment, the injection guide may have a cross-section in a U-shape or a ‘[’ shape along a liquid flow direction.

According to an embodiment, a through-hole may be formed in at least one end of the first guide portion and may contact an inner peripheral surface of the case in the first direction.

According to an embodiment, a through-hole may be formed in at least one end of the second guide portion and may contact the inner peripheral surface of the case in the second direction.

According to another aspect of the present disclosure, a battery cell includes an electrode assembly; a container accommodating the electrode assembly in an inner space and including an injection port through which liquid injected in an injection direction toward the electrode assembly passes; and an injection guide disposed between the injection port and the electrode assembly to guide the liquid injected from the injection port to the electrode assembly, wherein the injection guide extends in a first direction perpendicular to the injection direction and a second direction perpendicular to the first direction, and to guide the liquid injected from the injection port to a position spaced apart from the injection port in the first direction and the second direction.

Above, the solution according to the present disclosure has been described, but this is only an example, and even if other configurations not mentioned herein are added, they should be understood to be included in the present disclosure.

### Advantageous Effects of Invention

According to an aspect of the present disclosure, a battery cell may prevent fluids, such as electrolyte or the like, injected through the injection port from directly contacting an electrode assembly.

According to the present disclosure, the battery cell may ensure that fluids, such as electrolyte or the like, injected through the injection port are evenly distributed and flow within a case.

### BRIEF DESCRIPTION OF DRAWINGS

FIG. 1 is a perspective view of a battery cell according to an embodiment.

FIG. 2 is an exploded perspective view of a battery cell according to an embodiment.

FIG. 3 is a cross-sectional view of a battery cell according to an embodiment.

FIG. 4a is a side view of an injection guide according to an embodiment.

FIG. 4b is a perspective view of an injection guide according to another embodiment.

FIG. 5 is a cross-sectional view taken along line I-I′ of FIG. 4a.

FIG. 6 is a drawing showing liquid flow through a projection of a cap plate.

FIG. 7 is a modified example of an injection guide.

FIG. 8 is another modified example of an injection guide.

### BEST MODE FOR THE INVENTION

Before proceeding to a detailed description of the embodiments, it should be noted that the terms and words used in the following description and claims should not be construed as limited to their conventional or dictionary meanings. Based on the principle that inventors may appropriately define the concepts of terms to best describe their inventions, they should be interpreted with meanings and concepts consistent with the technical spirit of the present disclosure.

Identical reference numbers or symbols in respective drawings represent components or elements that perform substantially the same functions. For convenience of explanation and understanding, the same reference numbers or symbols may be used in different embodiments.

In the following description, the singular expression includes the plural expression unless the context clearly indicates otherwise. Terms such as “comprises,” “configured” or the like are intended to indicate the presence of features, numbers, steps, operations, components, parts, or combinations thereof described in the specification, but should be understood not to preclude the presence or addition of one or more other features, numbers, steps, operations, components, parts, or combinations thereof.

In addition, in the following description, terms such as “top,” “upper,” “lower,” “below,” “side,” “front,” “rear,” and the like are expressed based on the directions illustrated in the drawings, and it is noted in advance that they may be expressed differently if the orientation of the corresponding object changes.

Furthermore, terms including ordinal numbers, such as “first,” “second,” and the like may be used to distinguish between components in the following description and claims. These ordinal numbers are used to distinguish identical or similar components, and the use of these ordinal numbers should not be interpreted as limiting the meaning of the terms. For example, the order of use or disposition or the like of components associated with these ordinal numbers should not be construed as limited by their numbers. If necessary, respective ordinal numbers may be used interchangeably.

Hereinafter, a battery cell according to the present disclosure will be described with reference to the drawings.

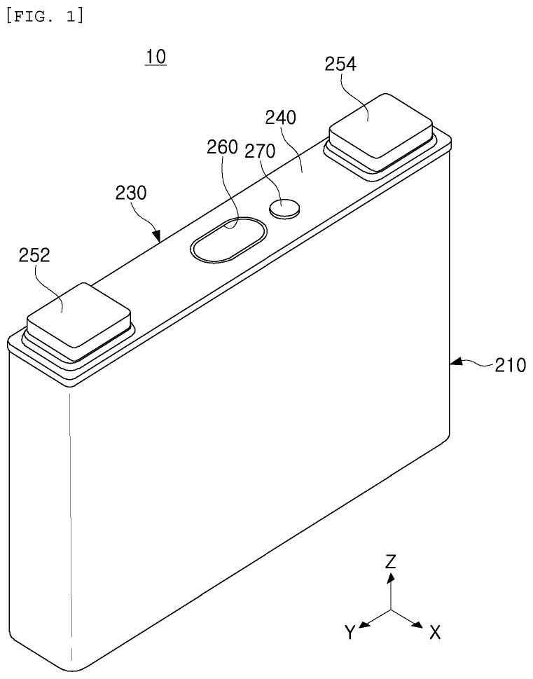

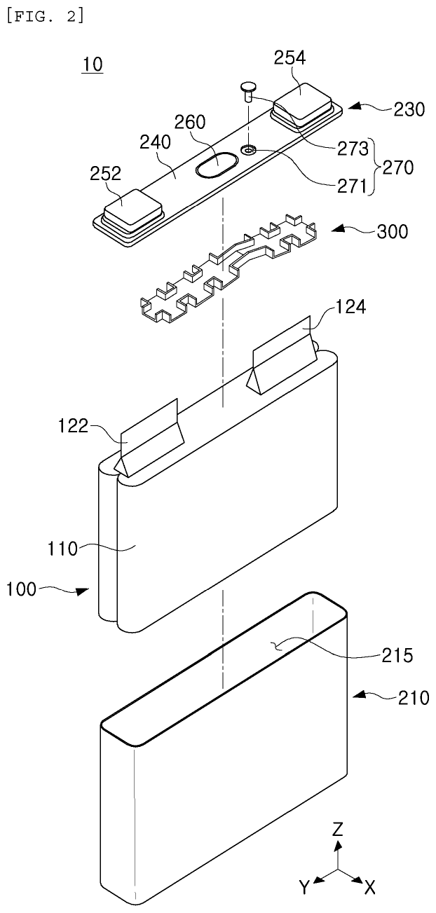

FIG. 1 is a perspective view of a battery cell according to an embodiment, and FIG. 2 is an exploded perspective view of the battery cell according to an embodiment.

Referring to FIGS. 1 and 2 together, a battery cell (10) according to an embodiment of the present disclosure may include an electrode assembly (100), a container (200) that accommodates the electrode assembly (100) in an inner space thereof and includes an injection port (271) through which liquid injected into the inner space passes along an injection direction toward the electrode assembly (100), and an injection guide (300) disposed between the electrode assembly (100) and the injection port (271) in the inner space. Here, the injection guide (300) may guide the liquid injected into the inner space in a first direction and a second direction perpendicular to the injection direction.

Here, the first and second directions only need to be perpendicular to the injection direction (Z-axis direction), and the first and second directions do not necessarily need to be perpendicular to each other.

The battery cell (10) of the present disclosure is depicted as a prismatic cell in the drawing, but this is for ease of understanding. The present disclosure is not limited to the external appearance or battery type shown in the drawing. Cylindrical cells, pouch-type cells, or the like may also be considered within the present disclosure as long as they have an injection port through which electrolyte or the like, and other fluids may be introduced.

The electrode assembly (100) may be formed by sequentially stacking a plurality of electrode plates in a predetermined direction. In detail, the electrode assembly (100) may be formed by sequentially stacking one or more cathodes coated with a cathode active material, one or more anodes coated with an anode active material, and a separator disposed therebetween.

The separator may be configured to prevent electrical short-circuiting between the cathode plate and the anode plate and to facilitate ion flow. For example, the separator may include a porous polymer film or porous non-woven fabric.

Additionally, the electrode assembly (100) may be configured as a jelly roll type, formed by winding in a predetermined direction. In detail, based on the drawing, a plurality of electrode plates may be stacked in the thickness direction (X-axis direction), and the electrode tabs may protrude in a height direction (Z-axis direction) perpendicular thereto, to be electrically connected to the cap assembly (230) described below. However, the electrode assembly (100) of the present disclosure is not limited thereto and should be interpreted to include any structure in which the cathode, separator, and anode are sequentially and repeatedly stacked, such as a stacking type, a zigzag folding type, a stack-folding type, or the like.

The electrode assembly (100) may be configured as a plurality of electrode plates stacked in a predetermined direction, as shown in the drawing. However, the battery cell (10) of the present disclosure is not limited by the number of electrode assemblies (100) or the winding configuration.

The electrode assembly (100) may include a cell body (110) in which a plurality of electrode plates (not shown) are stacked, and cell tabs (122, 124) protruding from the cell body (110) and electrically connected to electrode terminals (252, 254) described below.

The container (200) may accommodate the electrode assembly (100) in its inner space. The container may include a case (210) having an opening (215) for accommodating the electrode assembly (100), and a cap assembly (230) coupled to the case to cover the opening (215).

In an embodiment, the container (200) is provided in a hexahedral shape, but is not necessarily limited thereto, as long as it is the structure in which the case (210) for accommodating the electrode assembly and the cap assembly (230) covering the case (210) may be provided. For example, if the battery cell (10) is a cylindrical cell, the container may be provided in a cylindrical shape.

Furthermore, the container (200) may be provided with an injection port (271) through which liquid injected into the container passes. The injection port (271) may be formed in at least one of the case (210) and the cap assembly (230), as described below, but considering the rigidity of the case, may be provided in the cap assembly (20).

The injection port (271) may be disposed to face the electrode assembly (100) in the injection direction.

Here, the “injection direction” may refer to the direction in which the electrode assembly (100) and the injection port (271) face each other, the penetration direction of the injection port (271), or the height direction (Z-axis direction) of the electrode assembly (100).

Meanwhile, the “liquid” described in the present disclosure may include any fluid introduced through the injection port (271). In detail, the “liquid” in the present disclosure may refer to the electrolyte impregnated into the electrode assembly (100), but is not necessarily limited to the electrolyte. Any fluid which may be injected through the injection port (271) and of which a flow direction may be guided by the injection guide (300) described below should be understood to fall within the scope of the present disclosure.

The case (210) may have a receiving space formed therein and may accommodate the electrode assembly (100). Furthermore, the case (210) may accommodate liquid injected through the injection port (271).

The case (210) may protect the electrode assembly (100) from the external environment and maintain the external appearance of the battery cell (10).

For example, the case (210) may include a metal material such as steel, aluminum alloy, stainless steel or the like to ensure sufficient rigidity.

However, the material of the case (210) in the present disclosure is not specifically limited, and it should be understood that any material capable of maintaining the external appearance of the battery cell (10) to the extent that the electrode assembly (100) may be accommodated therein is not particularly limited.

In an embodiment, the case (210) has an opening formed in one side, allowing the electrode assembly (100) to enter the case. On the other hand, while the opening (215) is described as being formed in one side in one embodiment, the case (210) according to the present disclosure is not limited thereto. For example, in the case of a bidirectional battery cell (10) in which the cell tabs (122, 124) of the electrode assembly (100) protrude in both directions, the openings (215) may be formed on both sides of the case (210).

The cap assembly (230) is provided to cover the opening and may be coupled to the case (210). The cap assembly (230) may include a cap plate (240) that covers the opening (215) of the case (210) and seals the inner space of the case (210).

The cap plate (240) may be formed of a material with sufficient strength to ensure mechanical rigidity, and may be formed of the same material as the case (210) to distribute shock from the case (210).

Furthermore, the cap assembly (230) may be provided with electrode terminals electrically connected to the cell tabs (122, 124) of the electrode assembly (100) housed in the inner space of the case (210). The electrode terminals (252, 254) may include a first electrode terminal (252) that contacts the first cell tab (122) of the electrode assembly (100) and a second electrode terminal (254) that contacts the second cell tab (124) of the electrode assembly (100).

The first cell tab (122) and the second cell tab (124) may be provided with different electrical polarities, and in this case, the first electrode terminal (252) and the second electrode terminal (254) may also be provided with different electrical polarities.

Meanwhile, while the drawing illustrates that the first electrode terminal (252) and the second electrode terminal (254) may be formed by protruding in the same direction, the present disclosure is not limited thereto. In the case of the bidirectional battery cell described above, the first electrode terminal (252) may be disposed on one side of the case (210), and the second electrode terminal (254) may be disposed on the other side of the case (210), to face each other.

According to an embodiment, the cap assembly (230) may include a venting portion (260) configured to discharge gas generated within the inner space of the case (210).

The venting portion (260) may include a venting hole (261) formed by penetrating through the cap assembly (230) and a venting cap (263) configured to close the venting hole (213) and rupture at a predetermined pressure. If flames and gas are generated inside the container (200) due to damage to the electrode assembly (100) or the like, the venting cap (263) ruptures, allowing the gas to escape to the outside of the case (210) through the venting hole (261), thereby preventing the battery cell (10) from exploding.

According to an embodiment of the present disclosure, the aforementioned injection port (271) may be provided in the cap plate (240) of the cap assembly (230). In detail, the cap assembly (230) may include an injection port (271) formed by penetrating the cap plate (240) to allow liquid to be injected into the inner space of the case.

The injection port (271) may be formed to penetrate the cap plate (240) in the thickness direction (i.e., the injection direction or Z-axis direction). Accordingly, liquid injected through the injection port (271) may pass through the cap plate and be injected into the inner space of the case (210). Additionally, according to the present disclosure, a filler cap (273) that seals the injection port (271) may further be included.

Meanwhile, while the drawing illustrates the injection port (271) as being formed by penetrating through the cap plate (240), the injection port (271) of the present disclosure is not limited thereto. Any injection port (271) that may be formed through the container (200) housing the electrode assembly (100) to allow liquid to be injected therethrough may be included.

Based on the injection direction (Z-axis direction, facing the electrode assembly (100)) along which liquid is injected through the injection port (271), the injection port (271) and the electrode assembly (100) may be disposed such that at least a portion of the injection port (271) overlaps with each other.

Here, “overlapping” means that the electrode assembly (100) is disposed such that the projection of the injection port (271) in the injection direction overlaps with the surface of the electrode assembly (100).

That is, since the electrode assembly (100) fills as much of the inner space of the case (210) as possible for energy efficiency, the injection port (271) and the electrode assembly (100) may be disposed to overlap each other in the injection direction described above.

In this structure, since the electrode assembly (100) is disposed parallel to the injection direction, the relatively high-pressure liquid passing through the injection port (271) may directly impact the electrode assembly.

If the liquid passing through the injection port (271) directly impacts the electrode assembly (100), the stacking Structure of the electrode assembly (100) may become disrupted, the electrode assembly (100) may break, or the like, thereby reducing durability of the electrode assembly (100). If the durability of the electrode assembly (100) is reduced, there is a risk of a short circuit occurring in the electrode assembly (100) during charging and discharging of the battery cell (10).

Accordingly, according to an embodiment of the present disclosure, the battery cell (10) may prevent relatively fast-flowing liquid injected through the injection port (271), from flowing immediately toward the electrode assembly (100), through the injection guide (300) disposed between the inner space of the case (210) and the electrode assembly (100) and guiding the liquid injected through the injection port (271).

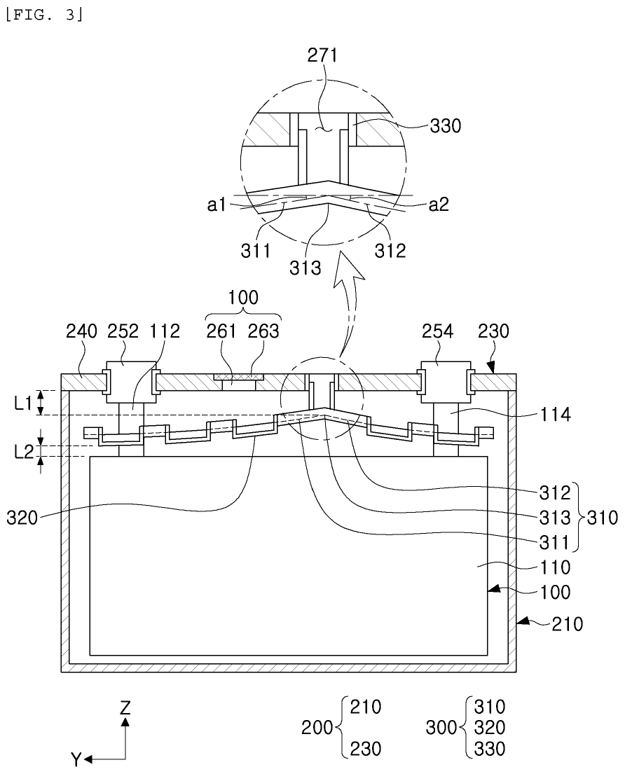

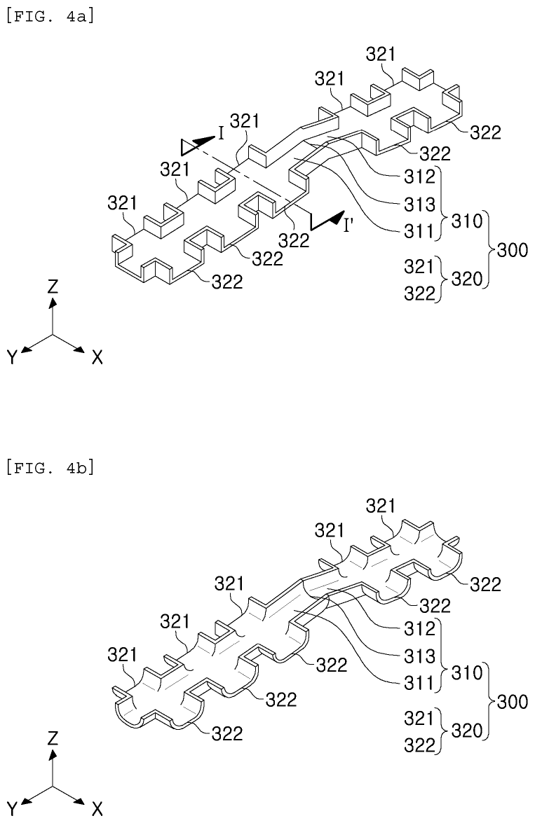

FIG. 3 is a cross-sectional view of a battery cell according to an embodiment, FIG. 4a is a side view of the injection guide according to an embodiment, FIG. 4b is a perspective view of the injection guide according to another embodiment, and FIG. 5 is a cross-sectional view taken along line I-I′ of FIG. 4a.

Referring to FIGS. 3 to 5 together, the injection guide (300) according to an embodiment of the present disclosure may include a first guide portion (310) that guides liquid flowing in an injection direction (a direction in which the electrode assembly (100) and the injection port (271) face each other, the Z-axis direction in the drawing) through the injection port (271), in a first direction (Y-axis direction) perpendicular to the injection direction, and a second guide portion (320) that guides the liquid flowing in the first direction through the first guide portion (310) in a second direction (X-axis direction) perpendicular to the first direction.

The first guide portion (310) may extend in the first direction, and the second guide portion (320) may extend from the first guide portion (310) in the second direction. Through this structure, the injection guide (300) may guide and discharge the liquid injected from the injection port (271) to a position spaced apart from the injection port (271) in the first and second directions.

Here, the “first direction” and “second direction” refer to directions perpendicular to the injection direction and are not necessarily limited to the Y-axis and X-axis directions.

The first guide portion (310) may be provided to be inclined in the first direction toward the electrode assembly (100). The first guide portion (310) may include guide inclined portions (311, 312) that are provided to be inclined toward the electrode assembly (100) from the injection port (271).

In more detail, the first guide portion (310) may include a fluid distribution portion (313) facing the injection port (271) in the injection direction, a first guide inclined portion (311) extending inclinedly from the fluid distribution portion (313) toward one side (+Y direction) in the first direction, and a second guide inclined portion (312) extending inclinedly from the fluid distribution portion (313) toward the Other side (−Y direction) in the first direction.

Since the first guide inclined portion (311) and the second guide inclined portion (312) are provided inclinedly from the fluid distribution portion (313) toward the electrode assembly (100), the fluid distribution portion (313) disposed therebetween may be disposed closest to the injection port (271) based on the injection direction (Z-axis direction) among the flow paths of the first guide portion (310).

The second guide portion (320) may be inclined in the second direction toward the electrode assembly (100). In more detail, the second guide portion (320) may include a first discharge inclined portion (321) extending inclinedly from the first guide portion (310) toward one side (−X direction) and a second discharge inclined portion (322) extending inclinedly from the first guide portion (310) toward the other side (+X direction).

The first discharge inclined portion (321) and the second discharge inclined portion (322) may be provided in multiple numbers and disposed longitudinally along the first direction. In the drawing, the first discharge inclined portion (321) and the second discharge inclined portion (322) are depicted as facing each other and disposed in the second direction, but are not limited thereto, and the first discharge inclined portion (321) and the second discharge inclined portion (322) may alternatively be disposed in a zigzag pattern along the first direction.

Furthermore, the injection guide (300) may be designed to appropriately avoid interference with the cell tabs (122, 124). For example, the injection guide (300) may be appropriately disposed to allow the first cell tab (122) to pass between the first guide inclined portion (311) and the two second guide portions (320), and the second cell tab (124) to pass between the second guide inclined portion (312) and the two second guide portions (320).

The injection guide (300) may further include a guide fixing portion (330) to ensure its position is fixed. The guide fixing portion (330) may be designed to protrude upward from the first guide portion (310) or the second guide portion (320) and be inserted and fitted at least partially into the injection port (271).

The injection guide (300) may be fitted into the injection port (271) via the guide fixing portion (330). At this time, the injection guide (300) is fitted into the injection port (271) via the guide fixing portion (330) and fixed at a predetermined position, and may thus be fixed at the predetermined position without interference with the adjacent cell tabs (122, 124).

The injection guide (300) may be disposed closer to the electrode assembly (100) than the injection port (271). In other words, referring to FIG. 3, a shortest distance (L1) between a highest portion (which may be the fluid distribution portion (313) described below) of the flow path of the injection guide (300) and the injection port (271) may be greater than a shortest distance (L2) (which may be the end of the second guide portion (320)) between a lowest portion of the flow path of the injection guide (300) and the electrode assembly (100).

That is, the injection guide (300) may be disposed such that the shortest distance (L1) from the injection port (271) may be greater than the shortest distance (L2) from the electrode assembly (100) based on the injection direction (Z-axis). (L1>L2)

Here, L1 may refer to the distance between a portion of the injection guide (300) closest to the injection port (271), excluding the fixing member (the guide fixing portion, 330) of the injection guide (300), and a portion of the injection port (271) closest to the injection guide (300). In addition, L2 may refer to the distance between a portion of the injection guide (300) closest to the electrode assembly (100) and a portion of the electrode assembly (100) (which may be the cell body (110)) closest to the injection guide (300) except for the electrical connection unit (the cell tabs (122, 124)).

Through this arrangement structure, damage to the electrode assembly (100) may be minimized by reducing the height difference between the electrode assembly (100) and the liquid.

In addition, referring to FIGS. 4a and 4b, the injection guide (300) may be provided in a shape in which the cross-section is concave to form a flow path to guide liquid from the first direction to the second direction. For example, as shown in FIG. 4a, the injection guide (300) may be provided in a shape in which a cross-section has a “[” shape and a partition wall is formed on both side surfaces, and as shown in FIG. 4b, the injection guide (300) may be provided in a shape bent in a “U” shape.

Referring again to FIG. 3, the first guide inclined portion (311) may be provided to slope from the fluid distribution portion (313) toward one side with a first guide inclination angle (a1), and the second guide inclined portion (312) may be provided to slope from the fluid distribution portion (313) toward the other side with a second guide inclination angle (a2). The angles of the first guide inclination angle (a1) and the second guide inclination angle (a2) may be greater than 0 degrees and 45 degrees or less.

The first guide inclination angle (a1) and the second guide inclination angle (a2) are provided at opposite angles relative to the fluid distribution portion (313), to be disposed at the same angle, thereby preventing the fluid from rapidly flowing in one direction.

Meanwhile, the first guide inclination angle and the second guide inclination angle (a1, a2) do not necessarily need to be identical to each other and may be appropriately modified depending on the design.

Referring to FIG. 5, the first discharge inclined portion (321) may be inclined from one side of the first guide portion (310) with a first discharge inclination angle (b1), and the second discharge inclined portion (322) may be inclined from the other side of the first guide portion (310) with a second discharge inclination angle (b2).

The angles of the first discharge inclination angle (b1) and the second discharge inclination angle (b2) may be greater than 0 degrees and 45 degrees or less.

The first discharge inclination angle (b1) and the second discharge inclination angle (b2) may be disposed at the same angle. Meanwhile, the first discharge inclination angle and the second discharge inclination angle (b1, b2) do not necessarily need to be identical and may be appropriately modified depending on the design, such as the shape of the case (210), the position of the electrode assembly (100), or the like.

Furthermore, the guide inclination angles (a1, a2) may be greater than the discharge inclination angles (b1, b2). This is because the first guide portion (310) may be longer than the second guide portion (320) (see FIG. 4), requiring the liquid to travel a greater distance. In other words, the flow rate of the liquid moving through the first guide portion (310) may be higher than the flow rate of the liquid transported through the second guide portion (320).

The second guide portion (320) guides liquid to the electrode assembly (100) through the ends of the discharge inclined portions (321, 322), and therefore, to reduce the hydraulic pressure applied to the electrode assembly (100), the discharge inclination angles (b1, b2) and the like may be adjusted so that the liquid thereby moves more slowly than on the first guide portion (310).

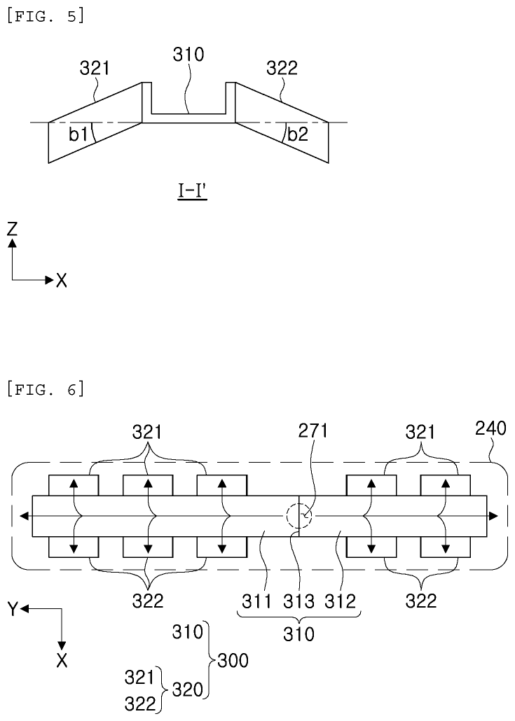

FIG. 6 is a drawing illustrating liquid flow by projecting the cap plate.

Referring to FIG. 6, the fluid distribution portion (313) may be disposed such that at least a portion thereof Overlaps the injection port (271) in the injection direction (Z-axis).

Here, “overlapping” means that the injection port (271) is disposed such that the projection of the injection port (271) in the injection direction overlaps the injection guide (300), in detail, the fluid distribution portion (313).

The liquid injected through the injection port (271) may first contact the fluid distribution portion (313) in the flow path of the injection guide (300). The liquid in contact with the fluid distribution portion (313) may flow by being divided into two branches along the first direction (Y-axis direction) through the first guide inclined portion (311) and the second guide inclined portion (312) of the first guide portion (310), and then flow by being again divided into two branches in the second direction (X-axis direction) through the first discharge inclined portion (321) and the second discharge inclined portion (322) of the second guide portion (320).

Through this, the hydraulic pressure of the liquid flowing through the injection port (271) may be distributed and the liquid may be injected by being evenly distributed inside the case (210).

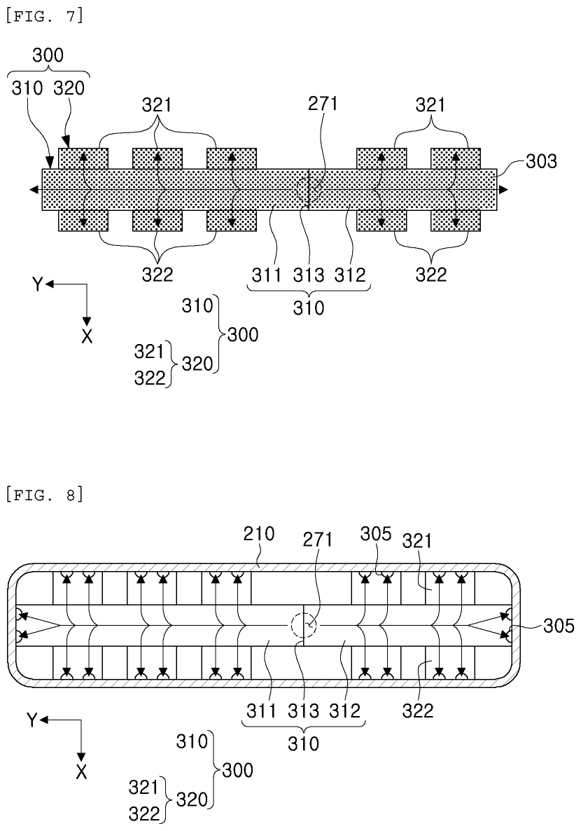

FIG. 7 illustrates a modified example of the injection guide, and FIG. 8 illustrates another modified example of the injection guide.

In FIG. 7, the injection guide (300) may form a plurality of shower holes (303) by penetrating the flow path. The diameter of the shower holes (303) may be smaller than that of the injection port (271).

A plurality of shower holes (303) are formed throughout the first guide portion (310) and the second guide portion (320), allowing liquid flowing in the first and second directions to be dispersed as they pass through the plurality of shower holes (303) and flow toward the electrode assembly (100). This allows the liquid to be sprayed into the case (210) to ensure even impregnation of the electrode assembly (100), and hydraulic pressure to be distributed.

Referring to FIG. 8, at least a portion of the injection guide (300) may contact the inner peripheral surface of the case (210). In detail, the first guide portion (310) may have at least one end in the first direction contacting the inner surface of the case (210) that faces therewith, and the second guide portion (320) may also have at least one end in the second direction contacting the inner surface of the case (210) that faces therewith. Meanwhile, the term “end” here may refer to the portion where the liquid injected through the injection port (271) is discharged from the injection guide (300).

At this time, a through-hole (305) may be formed at the portion that contacts the inner surface of the case (210). The through-hole (305) may have a larger diameter than the shower hole (303). The through-hole (305) may be formed in a semicircular shape to increase the contact area between the liquid and the inner peripheral surface of the case (210). Through this structure, the liquid injected through the injection port (271) may be discharged through the through-hole (305) and flow along at least a portion of the inner peripheral surface of the case (210).

Furthermore, this prevents liquid from being directly injected into the electrode assembly (100) and allows the liquid to gradually rise from the bottom of the case (210).

While various embodiments of the present disclosure have been described in detail above, the scope of the present disclosure is not limited thereto. It will be apparent to those skilled in the art that various modifications and variations are possible without departing from the technical spirit of the present disclosure as defined in the claims. Certain components of the above-described embodiments may be omitted, and the respective embodiments may be combined with each other.

The above description is merely an example of the application of the principles of the present disclosure, and other configurations may be incorporated without departing from the scope of the present disclosure.

1. A battery cell comprising:
an electrode assembly;
a container accommodating the electrode assembly in an inner space and including an injection port through which liquid injected into the inner space passes along an injection direction toward the electrode assembly; and
an injection guide disposed between the electrode assembly and the injection port in the inner space,
wherein the injection guide guides the liquid injected into the inner space through the injection port in a first direction and a second direction, perpendicular to the injection direction.

2. The battery cell of claim 1, wherein the first direction and the second direction are perpendicular to each other.

3. The battery cell of claim 1, wherein the injection guide includes,
a first guide portion extending in the first direction to guide the liquid injected into the inner space in the injection direction in the first direction; and
a second guide portion extending from the first guide portion in the second direction to guide the liquid flowing in the first direction along the first guide portion, in the second direction.

4. The battery cell of claim 3, wherein the container includes,
a case having an opening formed therein to accommodate the electrode assembly; and
a cap plate coupled to the case to cover the opening, and
the injection port is formed by penetrating through the cap plate in the injection direction.

5. The battery cell of claim 3, wherein the first guide portion has a slope becoming closer to the electrode assembly as it moves away from the injection port that, with respect to the first direction.

6. The battery cell of claim 5, wherein the first guide portion includes,
a fluid distribution portion disposed below the injection port; and
a guide inclined portion extending inclinedly to both sides of the fluid distribution portion in the first direction,
wherein the fluid distribution portion is disposed closer to the injection port than the guide inclined portion, and the guide inclined portion is disposed closer to the electrode assembly than the fluid distribution portion.

7. The battery cell of claim 6, wherein the guide inclined portion includes,
a first guide inclined portion extending inclinedly toward one side of the fluid distribution portion in the first direction with a first guide inclination angle; and
a second guide inclined portion extending inclinedly toward the other side of the fluid distribution portion in the first direction with a second guide inclination angle.

8. The battery cell of claim 7, wherein the first guide inclination angle and the second guide inclination angle are the same.

9. The battery cell of claim 6, wherein the fluid distribution portion is disposed to at least partially overlap the injection port relative to the injection direction.

10. The battery cell of claim 4, wherein the second guide portion extends inclinedly from both sides of the first guide portion to approach the electrode assembly.

11. The battery cell of claim 10, wherein the second guide portion includes,
a first discharge inclined portion extending inclinedly from one side of the first guide portion with a first discharge inclination angle; and
a second discharge inclined portion extending inclinedly from the first guide portion with a second discharge inclination angle.

12. The battery cell of claim 11, wherein the first discharge inclination angle and the second discharge inclination angle are the same.

13. The battery cell of claim 11, wherein the second guide portion includes a plurality of first discharge inclined portions and a plurality of second discharge inclined portions,
wherein the plurality of first discharge inclined portions and the plurality of second discharge inclined portions are disposed to face each other in the first guide portion.

14. The battery cell of claim 10, wherein based on the injection direction, the first guide portion is disposed closer to the injection port than the second guide portion, and the second guide portion is disposed closer to the electrode assembly than the first guide portion.

15. The battery cell of claim 3, wherein the first guide portion and the second guide portion are each inclined at a predetermined angle to approach the electrode assembly, and an angle of inclination of the first guide portion is greater than an angle of inclination of the second guide portion.

16. The battery cell of claim 2, wherein the injection guide includes a plurality of shower holes formed to penetrate a flow path in the injection direction, the liquid flowing through the flow path.

17. The battery cell of claim 1, wherein the injection guide has a shortest distance (L1) from the injection port and a shortest distance (L2) from the electrode assembly, based on the injection direction, the shortest distance (L1) from the injection port being greater.

18. The battery cell of claim 4, wherein at least one of at least one end of the first guide portion and at least one end of the second guide portion is in contact with an inner surface of the case, and a through hole is formed in the one end.

19. The battery cell of claim 1, wherein the injection guide further includes a guide fixing portion fitted and fixed to the injection port.

20. A battery cell comprising:
an electrode assembly;
a container accommodating the electrode assembly in an inner space and including an injection port through which liquid injected in an injection direction toward the electrode assembly passes; and
an injection guide disposed between the injection port and the electrode assembly to guide the liquid injected from the injection port to the electrode assembly,
wherein the injection guide extends in a first direction and a second direction, perpendicular to the injection direction, and discharges the liquid injected from the injection port, from a location spaced apart from the injection port in the first direction and the second direction.
